(19) United States
(12) Patent Application Publication
(10) Pub. No.: US 2026/0266709 A1
(43) Pub. Date: Sep. 10, 2026

(54) SYSTEMS AND METHODS FOR CORROSION FATIGUE ASSESSMENT

(71) Applicant: George Mason University, Fairfax, VA (US)

(72) Inventors: Mehdi Amiri, Sterling, VA (US); Leila Saberi, Hanover, MD (US)

(21) Appl. No.: 19/560,841

(22) Filed: Mar. 9, 2026

Related U.S. Application Data
(60) Provisional application No. 63/769,500, filed on Mar. 10, 2025.

(51) Int. Cl. G01N 17/02; G01N 17/00

(52) U.S. Cl. CPC G01N 17/02; G01N 17/006

(57) ABSTRACT

A system for predicting a service life of a metal component subjected to cyclic mechanical loading in a corrosive environment includes a corrosion sensor configured to measure electrochemical currents in a metal component under static loading. The electrochemical currents in the metal component under static loading are indicative of a static corrosion current density, i_{corr, static}, of the metal component. The system further includes a controller including a processor configured to receive corrosion data from the corrosion sensor indicative of the measured electrochemical currents, obtain environmental data relating to a corrosive environment, obtain loading data relating to mechanical loading of the metal component, and predict a service life of the metal component based on the corrosion data, the environmental data, and the loading data.

### CROSS-REFERENCE TO RELATED APPLICATIONS

This application claims the benefit of U.S. Provisional Patent Application No. 63/769,500, filed on Mar. 10, 2025, the entire contents of which are hereby incorporated herein by reference.

### FIELD

The present disclosure relates to corrosion fatigue assessment and, more specifically, to systems and methods for corrosion fatigue assessment such as, for example, to facilitate the prediction of the service life of a metal component subjected to cyclic mechanical loading in a corrosive environment.

### BACKGROUND

Metal components are ubiquitous across many different industries including aerospace, maritime, industrial manufacturing, chemical processing, construction, energy, mining, automobiles, and agriculture, to name a few. When metal components are subjected to mechanical loading in corrosive environments, the metal components can be impacted by corrosion fatigue, leading to crack initiation and, ultimately, structural failure. The combined effect of the corrosive environment and the mechanical loading can be larger than the effect of each acting separately.

Corrosion fatigue testing is typically performed by cyclic application of mechanical loading to a metal component while simultaneous exposing the metal component to a corrosive environment. This cycle is repeated a large number of times until the metal component fails or until a predetermined number of cycles is reached without failure. Corrosion fatigue testing in this manner is expensive, time-consuming, and destructive to the metal component.

### SUMMARY

To the extent consistent, any of the aspects detailed herein may be used in conjunction with any or all of the other aspects detailed herein.

Provided in accordance with aspects of the present disclosure is a system for predicting a service life of a metal component subjected to cyclic mechanical loading in a corrosive environment. The system includes a corrosion sensor configured to measure electrochemical currents in a metal component under static loading. The electrochemical currents are indicative of a static corrosion current density, i_{corr, static}, of the metal component. The system further includes a controller including a processor and a non-transitory computer-readable storage medium storing instructions that, when executed by the processor, cause the processor to receive corrosion data from the corrosion sensor indicative of the measured electrochemical currents, obtain environmental data relating to a corrosive environment, obtain loading data relating to mechanical loading of the metal component, and predict a service life of the metal component based on the corrosion data, the environmental data, and the loading data.

In aspects of the present disclosure, the system further includes at least one environmental sensor configured to sense at least one property of the corrosive environment. Obtaining the environmental data, in such aspects, may include receiving sensed data from the at least one environmental sensor.

In aspects of the present disclosure, the system further includes at least one load sensor configured to sense at least one property of the mechanical loading of the metal component. In such aspects, obtaining the loading data includes receiving sensed data from the at least one load sensor.

In aspects of the present disclosure, the processor is further caused to correlate the static corrosion current density, i_{corr, static}, with a fatigue corrosion current density, i_{corr, fatigue}. In such aspects, predicting the service life of the metal component is based on the fatigue corrosion current density, i_{corr, fatigue}.

In aspects of the present disclosure, at least one of the corrosion data, the environmental data, or the loading data corresponds to data from a number of cycles of cyclic mechanical loading of the metal component in the corrosive environment. The number of cycles is from 1 cycle to 10 cycles.

In aspects of the present disclosure, predicting the service life of the metal component includes predicting a life until fatigue-crack initiation. In alternative or additional aspects, predicting the service life of the metal component includes predicting a number of cycles of mechanical loading of the metal component in the corrosive environment.

A method for predicting a service life of a metal component subjected to cyclic mechanical loading in a corrosive environment in accordance with the present disclosure includes sensing electrochemical currents in a metal component under static loading indicative of a static corrosion current density, i_{corr, static}, of the metal component, obtaining environmental data relating to a corrosive environment, obtaining loading data relating to mechanical loading of the metal component, and predicting a service life of the metal component based on corrosion data indicative of the measured electrochemical currents, the environmental data, and the loading data.

In aspects of the present disclosure, obtaining the environmental includes sensing at least one property of the corrosive environment and/or obtaining the loading data includes sensing at least one property of the mechanical loading of the metal component.

In aspects of the present disclosure, the method further includes correlating the static corrosion current density, i_{corr, static}, with a fatigue corrosion current density, i_{corr, fatigue}.

In aspects of the present disclosure, at least one of the corrosion data, the environmental data, or the loading data corresponds to data from a number of cycles of cyclic mechanical loading of the metal component in the corrosive environment. The number of cycles may be from 1 cycle to 10 cycles.

In aspects of the present disclosure, predicting the service life of the metal component includes predicting a life until fatigue-crack initiation and/or predicting a number of cycles of mechanical loading of the metal component in the corrosive environment.

Another system in accordance with the present disclosure for predicting a service life of a metal component subjected to cyclic mechanical loading in a corrosive environment includes a sensor head and a controller. The sensor head includes at least one corrosion sensor configured to measure electrochemical currents in a metal component under static loading indicative of a static corrosion current density, i_{corr, static}, of the metal component, at least one environmental sensor configured to sense at least one property of a corrosive environment, and/or at least one load sensor configured to sense at least one property of a mechanical loading of the metal component. The controller is communicatively coupled to the sensor head and includes a processor and a non-transitory computer-readable storage medium storing instructions that, when executed by the processor, cause the processor to receive corrosion data from the at least one corrosion sensor of the sensor head indicative of the measured electrochemical currents, receive environmental data from the at least one environmental sensor of the sensor head indicative of at least one property of the corrosive environment, receive loading data from the at least one load sensor of the sensor head indicative of the at least one property of the mechanical loading of the metal component, and predict a service life of the metal component based on the corrosion data, the environmental data, and the loading data.

In aspects of the present disclosure, the controller is integrated into the sensor head. Alternatively, the controller may be remote from the sensor head during cyclic mechanical loading of the metal component in the corrosive environment.

In aspects of the present disclosure, the sensor head is integrated with the metal component or with a system including the metal component.

In aspects of the present disclosure, predicting the service life of the metal component includes predicting a life until fatigue-crack initiation and/or predicting a number of cycles of mechanical loading of the metal component in the corrosive environment.

### BRIEF DESCRIPTION OF DRAWINGS

The above and other aspects and features of the present disclosure will become more apparent in view of the following detailed description when taken in conjunction with the accompanying drawings wherein like reference numerals identify similar or identical elements.

FIG. 1 is a graph of experimental results in accordance with the present disclosure illustrating the relationship between normalized corrosion current measured during static testing and normalized corrosion currents measured during fatigue testing at the same load and for the same plastic strain;

FIGS. 2A and 2B are graphs of experimental results in accordance with the present disclosure illustrating the relationship between corrosion current densities measured during static testing and corrosion current densities measured during fatigue testing for two different concentrations of a corrosive solution;

FIG. 3 is a schematic illustration of a system provided in accordance with the present disclosure and configured for corrosion fatigue assessment of a metal component subjected to cyclic mechanical loading in a corrosive environment;

FIG. 4 is a block diagram illustrating a method provided in accordance with the present disclosure for corrosion fatigue assessment of a metal component subjected to cyclic mechanical loading in a corrosive environment;

FIGS. 5-8 are schematic illustrations of other systems provided in accordance with the present disclosure and configured for corrosion fatigue assessment of a metal component subjected to cyclic mechanical loading in a corrosive environment;

FIG. 9 is a perspective view illustrating a system in accordance with the present disclosure shown in use with an aircraft; and

FIG. 10 is a perspective view illustrating a system in accordance with the present disclosure shown in use supported by a mechanical arm.

### DETAILED DESCRIPTION

Systems and methods in accordance with the present disclosure provide corrosion fatigue assessment of a metal component subjected to cyclic mechanical loading in a corrosive environment such as, for example, to predict the service life of the metal component. The systems and methods of the present disclosure, more specifically, provide corrosion fatigue assessment of a metal component subjected to cyclic mechanical loading in a corrosive environment based on electrochemical data obtained with the metal component under static conditions, thus enabling rapid corrosion fatigue assessment without the need for fatigue (dynamic) load testing, component destruction, lengthy testing involving large numbers of test cycles, or expensive testing involving specialized test equipment.

The systems and methods of the present disclosure are applicable to a wide variety of corrosive environments and metallic materials and are informed by the electro-chemo-mechanical interactions underlying corrosion fatigue, thus enabling corrosion fatigue assessment with high accuracy. In aspects, the systems and methods of the present disclosure enable corrosion fatigue assessment of a metal component while in-service, thus allowing, for example, repeated determination, e.g., updating, of a predicted service life of the metal component as the metal component is used in-service. Such updating may enable more accurate prediction such as, for example, to account for changes associated with the cyclic mechanical loading and/or the corrosive environment. In these and/or other aspects, predicting the service life of the metal component may include predicting an occurrence of fatigue-crack initiation.

The systems and methods of the present disclosure enable evaluation of corrosion properties under fatigue loading from static tests based on a correlation between corrosion current and corrosion current density exhibited under fatigue loading with that exhibited under static loading. This correlation has been identified in accordance with the present disclosure and was confirmed through an experiment in accordance with the present disclosure wherein two different types of stainless steel 304L specimens (a smooth specimen and a compact tension (CT) specimen) were tested in two aqueous solutions with different NaCl concentrations (a solution with an NaCl concentration of 1wt.% and a solution with an NaCl concentration of 3.5 wt.%).

As part of this experiment, mechanical and corrosion tests were conducted using a fatigue tester equipped with a corrosion cell. For the corrosion tests, the CT and smooth specimens were used as working electrodes and a saturated calomel electrode was be used as the reference electrode. The counter electrode was a graphite bar. At the macro scale, a potentiostat was utilized to perform Tafel polarization tests in the NaCl solutions to measure the average corrosion properties of exposed surfaces of the specimens. At the micro scale, a scanning electrochemical microscopy (SECM) test was performed for localized line scanning of the specimens.

Testing was performed under both loaded and load-free conditions. The Tafel tests and the SECM tests were conducted at various different applied loads, e.g., 0, 222, 444, 889, and 1223 N applied loads. The fatigue tests were paused at a given number of cycles, followed by Tafel tests, to investigate the gradual alteration of the corrosion properties. The maximum applied load was kept for the entire duration of each Tafel test. During fatigue tests, the solution was periodically removed to monitor the specimen’s surface for crack initiation using a digital image correlation (DIC) technique. The tests continued until crack initiation was observed.

To ensure repeatability, the experiments conducted in accordance with this disclosure were repeated three times under the same condition. The results demonstrated consistent outcomes, indicating repeatability.

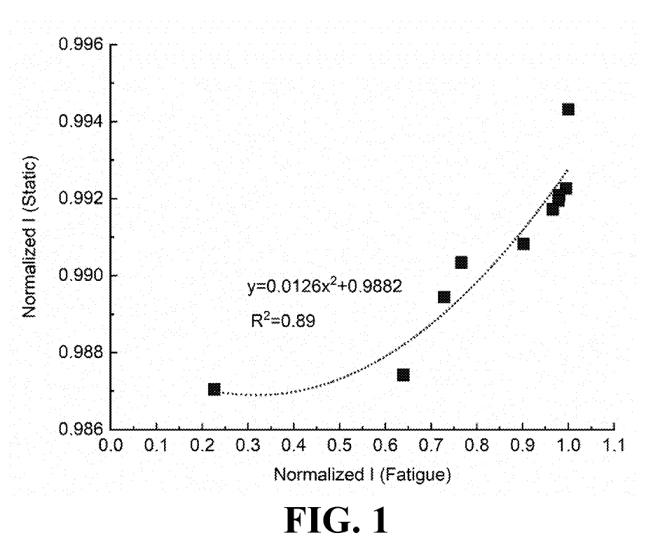

FIG. 1 illustrates results of the micro scale measurements of above-noted experiment and, more particularly, a relationship between normalized tip current (corrosion current) measurements from the SECM tests of the smooth and CT specimens for the same plastic strain. The data presented in FIG. 1 relates the corrosion properties of the specimens under fatigue loading to those of the specimens under static loading. The results show a highly correlated trend between the static and fatigue tip currents, thus confirming that the corrosion current of a dynamic fatigue test may be predicted from that of a static test. This correlation allows the systems and methods of the present disclosure to assess corrosion fatigue from static tests.

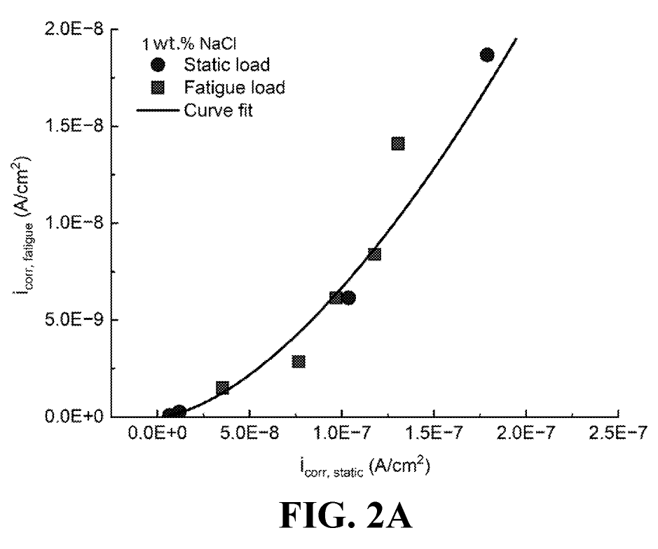

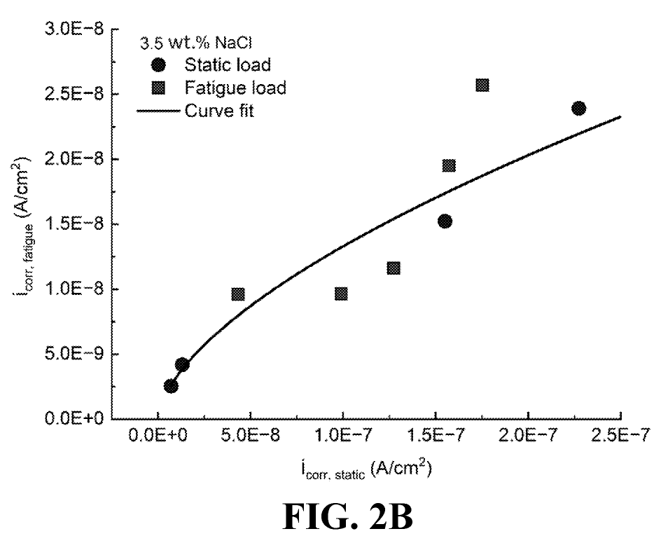

FIGS. 2A and 2B illustrate results of the macro scale measurements of above-noted experiment and, more particularly, the relationship between the corrosion current density for the static tests, i_{corr, static}, and the corrosion current density for the fatigue tests, tests, i_{corr, fatigue}, for each of the NaCl concentrations. The data presented in FIGS. 2A and 2B shows a highly correlated trend between the static and fatigue corrosion current density measurements for the 1wt.% NaCl solution and a relatively good correlation between the static and fatigue corrosion current density measurements for the 3.5 wt.% NaCl solution. These results thus confirm that the corrosion current density of a dynamic fatigue test may be predicted from that of a static test, allowing the systems and methods of the present disclosure to assess corrosion fatigue from static tests.

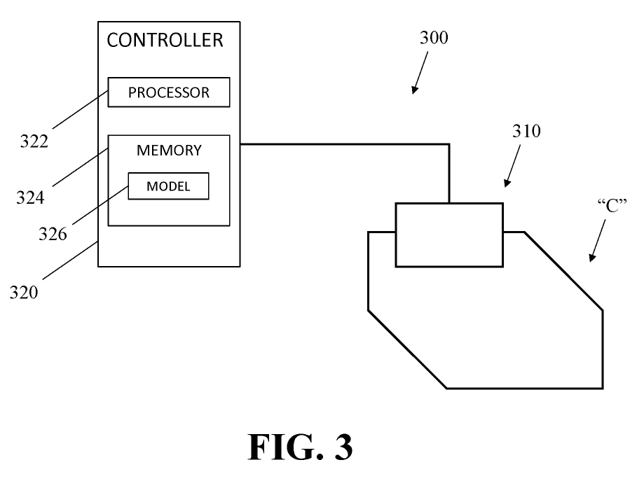

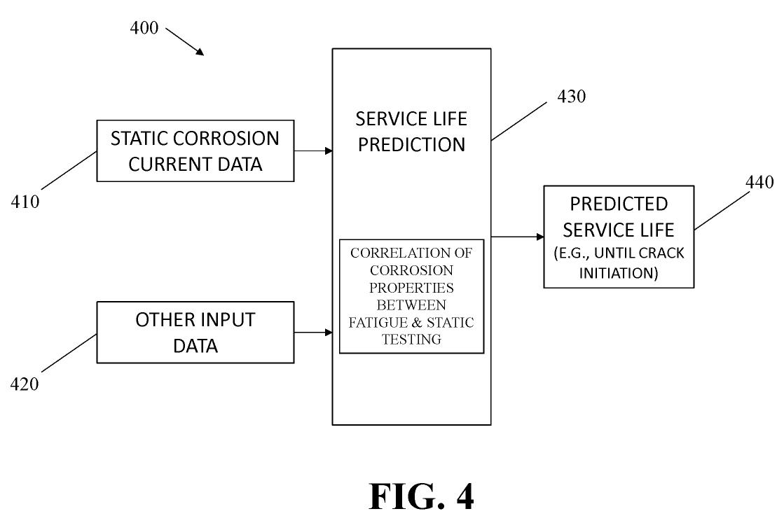

Turning to FIGS. 3 and 4, a system 300 and method 400, respectively, are provided in accordance with the present disclosure leveraging static testing of corrosion fatigue for predicting a service life of a metal component, e.g., metal component “C”, subjected to cyclic mechanical loading in a corrosive environment.

Metal component “C” is at least partially formed from a metal (including metal alloys) or a combination of metals (including metal alloys) and is subjected to repeated mechanical loading in a corrosive environment. Metal component “C” may be a component of an aerospace system (e.g., an aircraft such as an airplane or helicopter), a maritime system (e.g., a marine vessel such as a boat or submarine), an industrial manufacturing system, a chemical processing system, a construction system, an energy system (e.g., an energy generator such as a wind turbine), a mining system, an automobile, an agricultural system, or of any other suitable system. With respect to aerospace systems, as an example, metal component “C” may be a portion of an airframe, fastener, joint, shaft, pressure vessel, pipeline, engine assembly, or any other load-bearing structural component.

Although metal component “C” is shown schematically in FIG. 3 as a stand-alone component for illustration purposes, metal component “C” may be integrated into a system, e.g., an aerospace system such as an airplane or helicopter, and system 300 may be configured to predict the service life of metal component “C” without disassembly or removal of metal component “C” from its system. Further, at least a portion of system 300 may be an integral part of the system that includes metal component “C” and/or at least a portion of system 300 may be configured to removably couple to the system that includes metal component “C”.

Metal component “C” is exposed to a corrosive environment which may include, for example, seawater exposure, coastal atmospheres, microbials, pollution, humidity and temperature cycling, exhaust gases, chemical application, combinations thereof, and/or other corrosion-inducing environmental conditions.

Metal component “C” is subject to cyclic mechanical loading in the corrosive environment. With respect to an airplane, for example, the cyclic mechanical loading may be a flight cycle including, for example, takeoff, climb, cruise, descent/approach, and landing.

System 300 includes a corrosion sensor 310 configured to measure electrochemical currents in metal component “C”. Corrosion sensor 310 may be configured to measure electrochemical currents through any suitable electrochemical measurement technique including, without limitation, linear polarization resistance (LPR), electrochemical impedance spectroscopy (EIS), potentiostatic monitoring, and/or galvanostatic monitoring. The measured electrochemical currents may be, or may be utilized to calculate, the static corrosion current density, i_{corr, static}.

System 300 further includes a controller 320 configured to receive the measured electrochemical currents from corrosion sensor 310 and to calculate, based on the measured electrochemical currents, the static corrosion current density, i_{corr, static}. Alternatively, a processor of corrosion sensor 310 may be configured to calculate, based on the measured electrochemical currents, the static corrosion current density, i_{corr, static}, and to transmit the static corrosion current density, i_{corr, static}, to controller 320.

Controller 320 is configured to predict, based on the static corrosion current density, i_{corr, static}, and, in aspects, other data such as additional sensed data and/or empirical data, the service life of metal component “C”. The service life of metal component “C” may be the life of the metal component “C” until fatigue-crack initiation. The service life of metal component “C” may be provided as a number of cycles of use of metal component “C”, e.g., a number of cycles until fatigue-crack initiation, or any other suitable service life output such as, for example, an amount of active in-service time until fatigue-crack initiation, e.g., flight time of an aerospace system.

To enable prediction of the service life of metal component “C”, controller 320 includes a processor 322 (such as, for example, a microprocessor, a digital signal processor, an ASIC, a graphics processing unit (GPU), a field-programmable gate array (FPGA), or a central processing unit (CPU)) operably connected to a memory 324 which may be volatile type memory (e.g., RAM) and/or non-volatile type memory (e.g., flash media, disk media, etc.). Memory 324 stores instructions to be carried out by processor 322 and may include, for example, a model 326 for service life prediction.

Model 326 may be a physics-based model, empirical model, machine learning-based model, a combination of multiple models of similar or different type, or any other suitable model or models. With respect to machine learning, the model(s) may be trained using training data that is obtained in prior use, experimentally, via mathematical simulation, utilizing machine learning, using theoretical formulae, combinations thereof, etc. The machine learning model(s) may be trained and then deployed for use or may be continually trained and updated based on local and/or remote (from other systems) data. In aspects, training the machine learning model(s) may be performed by controller 320 or may be performed by a computing device or devices separate from controller 320 and then the resulting model(s) may be communicated to controller 320.

In aspects where a machine learning model(s) is utilized, the machine learning may include classification machine learning and/or one or more neural networks such as, for example, a long-short term memory network, a convolutional neural network (CNN), a recurrent adversarial network (RAN), a generative adversarial network (GAN) and/or other suitable neural network(s). As an alternative or in addition to a neural network, other suitable machine learning systems may be utilized such as, for example a support vector machine (SVM), and/or may implement: Bayesian Regression, Naive Bayes, nearest neighbors, least squares, means, and support vector regression, among other data science and artificial science techniques. Other suitable machine learning models are also contemplated.

Additional sensed data and/or empirical data for input to model 326 for use in predicting the service life of metal component “C” may include, for example, environmental data regarding the corrosive environment, load monitoring data associated with the load on metal component “C”, data associated with metal component “C” (e.g., metal type/composition, dimensions, thickness, etc.), and/or any other suitable data. In aspects, for example, wherein the corrosive environment and/or load are predictable for each cycle, the additional data may be empirical data previously sensed or otherwise obtained data that is stored by or communicated to controller 320 for use in executing model 326. On the other hand, in aspects, for example, wherein the corrosive environment and/or load are unpredictable for each cycle, the additional data may be sensed data provided from one or more additional sensors of system 300 or in communication (directly or indirectly) with system 300. However, the use of additional sensed data and/or empirical data is not limited to these scenarios. Further, in aspects, sensed data may be utilized as empirical data for subsequent service life predictions, e.g., until additional sensed data is obtained, until updated sensed data is requested, and/or until environmental or load conditions change, thus allowing for updating of the service life prediction without requiring updated sensed data for each update.

The environmental data regarding the corrosive environment may include relative humidity, pH level, temperature, a length of time in the corrosive environment, and/or any other environmental variables affecting electrochemical reaction rates. The environmental data may be sensed by one or more sensors configured to collect data continuously, periodically, or synchronously with cyclic loading events.

The load monitoring data associated with the load on metal component “C” may include stress amplitude, strain range, loading frequency, cycle count, mean stress, and/or any other suitable other fatigue-related variables. The load monitoring data may be sensed by one or more sensors configured to collect data continuously, periodically, or synchronously with cyclic loading events.

Method 400 of FIG. 4 may be executed by controller 320 of system 300 (FIG. 3) or any other suitable system. With respect to method 400, static corrosion current data is obtained at 410 (e.g., as the static corrosion current density, i_{corr, static}) and, in aspects, other input data is obtained at 420 (e.g., sensed data and/or empirical data). This data obtained at 410 and/or 420 is input to enable service life prediction at 430. Service life prediction at 430 may correlate the static corrosion current density, i_{corr, static}, with a fatigue corrosion current density, i_{corr, fatigue}, and determine, based upon the fatigue corrosion current density, i_{corr, fatigue}, and, in aspects, the data input at 420, predicted service life for output at 440. Alternatively, service life prediction at 430 may utilize the static corrosion current density, i_{corr, static}, and, in aspects, the other input data at 420, to determine the predicted service life for output at 440.

The service life prediction at 430 may include model 326 (FIG. 3) or any other suitable model to enable determination of the predicted service life for output at 440. In aspects, the static corrosion current data obtained at 410 and/or the other input data obtained at 420 (e.g., input data that is sensed data) is obtained over a number of cycles of mechanical loading of component “C” (FIG. 3) in the corrosive environment. In aspects, the number of cycles is from 1 cycle to 100 cycles; in other aspects, from 1 cycle to 50 cycles; in yet other aspects, from 1 cycle to 20 cycles; in still other aspects, from 1 cycle to 10 cycles; or, in still yet other aspects, from 1 cycle to 5 cycles. With respect to an aerospace system, for example, each cycle may correspond to a flight segment.

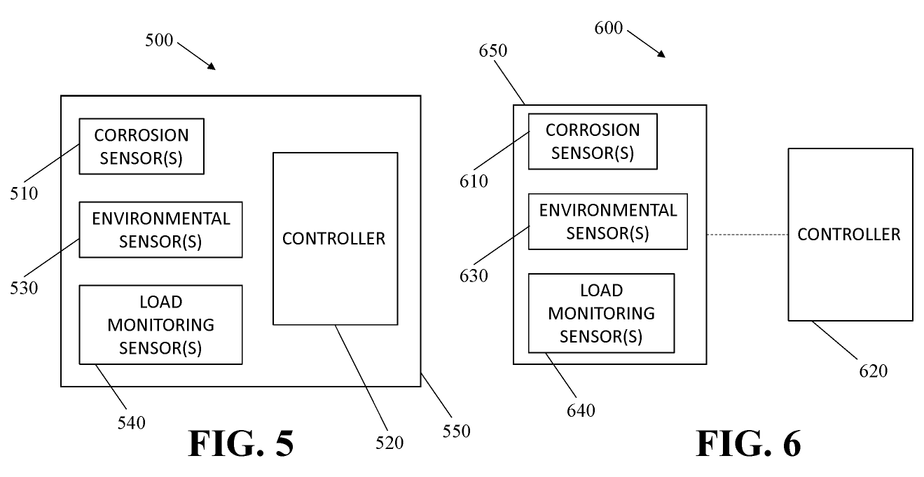

Referring to FIG. 5, another system 500 provided in accordance with the present disclosure that leverages static testing of corrosion fatigue for predicting a service life of a metal component is shown. System 500 may include any of the aspects and features of system 300 (FIG. 3) as detailed above and, thus, similarities between the systems are only summarily described below or omitted entirely for purposes of brevity. Further, system 500 may implement any of the aspects and/or features of method 400 (FIG. 4), as also detailed above and, thus, these similarities are likewise only summarily described below or omitted entirely for purposes of brevity.

System 500 includes one or more corrosion sensors 510 and a controller 520. System 500 further includes additional sensors such as, for example, one or more environmental sensors 530 configured to provide environmental data regarding the corrosive environment and/or one or more load monitoring sensors 540 configured to provide load monitoring data associated with the load on a metal component. Corrosion sensor(s) 510, controller 520, environmental sensor(s) 530, and load monitoring sensor(s) 540 are incorporated into a sensor head 550 as an integral unit.

The environmental data from the one or more environmental sensors 530 and/or the load monitoring data from the one or more load monitoring sensors 540 may be provided as sensed data for use by controller 520 in predicting the service life of a metal component, e.g., for input to a model executed by controller 520, similarly as detailed above with respect to model 326 of controller 320 and/or with respect to method 400 (FIGS. 3 and 4, respectively).

The one or more environmental sensors 530 may include humidity sensors, temperature sensors, pH sensors, or other suitable sensors configured to sense properties of the corrosive environment.

The one or more load monitoring sensors 540 may include one or more strain gauges, accelerometers, load cells, displacement sensors, or other suitable sensors configured to sense properties associated with the load on a metal component.

Additional or alternative sensors and/or other input data such as empirical data is also contemplated for use by controller 520 in predicting the service life of a metal component.

Sensor head 550 of system 500 may integrally connected to the metal component to be monitored for service life prediction and/or the system that includes the metal component to be monitored for service life prediction. In this context, integrally connected refers to the fact that sensor head 550 is configured to remain connected to the metal component and/or system thereof during one or more cycles of use of the system in-service. Alternatively, sensor head 550 of system 500 may be configured to releasably couple to the metal component to be monitored for service life prediction and/or the system that includes the metal component to be monitored for service life prediction. That is, sensor head 550 may be coupled to the metal component and/or system thereof between cycles of use of the system in-service.

With reference to FIG. 6, another system 600 provided in accordance with the present disclosure that leverages static testing of corrosion fatigue for predicting a service life of a metal component is shown. System 600 is similar to and may include any of the features of system 500 (FIG. 5), except that system 600 includes a sensor head 660 that includes the corrosion sensor(s) 610, environmental sensor(s) 630, and load monitoring sensor(s) 640, while the controller 620 is external of and, in aspects, remote from, sensor head 660.

Sensor head 650 of system 600 may be integrally connected to the metal component to be monitored for service life prediction and/or the system that includes the metal component to be monitored for service life prediction, or may be removably coupled thereto. In either configuration, sensor head 650 is configured to communicate the sensed data obtained by corrosion sensor(s) 610, environmental sensor(s) 630, and load monitoring sensor(s) 640 to controller 620. This communication may be wireless or by wired connection and may be provided continuously, periodically, and/or upon request. Controller 620 may be separate from the metal component to be monitored for service life prediction and/or the system that includes the metal component to be monitored for service life prediction, such as, for example, where controller 620 and sensor head 650 are selectively brought into communication to enable the sensed data to be communicated to controller 620. As an example, controller 620 and sensor head 650 may be brought into communication between cycles of use in-service of the system including the metal component to be monitored for service life prediction, e.g., at an airport, marine port, etc. However, sensor head 650 need not be the portion moved into communication with controller 620. Indeed, it is contemplated that controller 620 may be part of a mobile module that is moved to the system including the metal component to be monitored for service life prediction for testing and is subsequently removed.

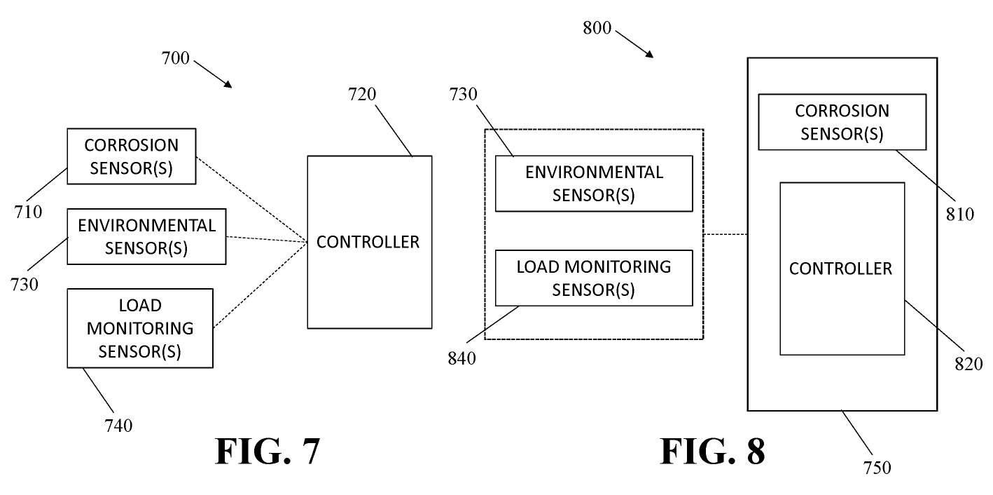

FIG. 7 illustrates another system 700 provided in accordance with the present disclosure that leverages static testing of corrosion fatigue for predicting a service life of a metal component is shown. System 700 is similar to and may include any of the features of system 600 (FIG. 6), except that, rather than incorporating the sensors in a sensor head, system 700 includes separate corrosion sensor(s) 710, environmental sensor(s) 730, and load monitoring sensor(s) 740. System 700 further includes a controller 720 that is separate from each of the sensors 710, 730, 740.

Any or all of sensors 710, 730, 740 may be integrally connected to the metal component to be monitored for service life prediction and/or the system that includes the metal component to be monitored for service life prediction, or may be removably coupled thereto. Controller 720 may likewise be integral or removably connectable.

With reference to FIG. 8, still another system 800 provided in accordance with the present disclosure that leverages static testing of corrosion fatigue for predicting a service life of a metal component is shown. System 800 is similar to and may include any of the features of systems 500-700 (FIGS. 5-7, respectively), except that system 800 includes a sensor head 850 that includes the one or more corrosion sensors 810 and controller 820 integrated into a single unit, while environmental sensor(s) 830 and load monitoring sensor(s) 840 are separate from sensor head 850 (and may be separate from one another or integrated with one another into a unit). Sensors 830, 840 may be integrally connected to the metal component to be monitored for service life prediction and sensor head 850 may be removably coupled thereto, although other configurations are also contemplated.

Referring generally to FIGS. 5-8, although various configurations of the sensors and controller of systems 500-800 are detailed above, other suitable configurations and arrangements are also contemplated. Further, it is contemplated that multiple sensor sets (e.g., each including one or more corrosion sensors, environmental sensors, and/or load monitoring sensors) may be couplable to a common controller such as, for example, to monitor multiple components of a system and/or to monitor components or multiple systems. Likewise, some sensors such as, for example, environmental sensors, may provide data for use in determining the service life prediction of multiple different components.

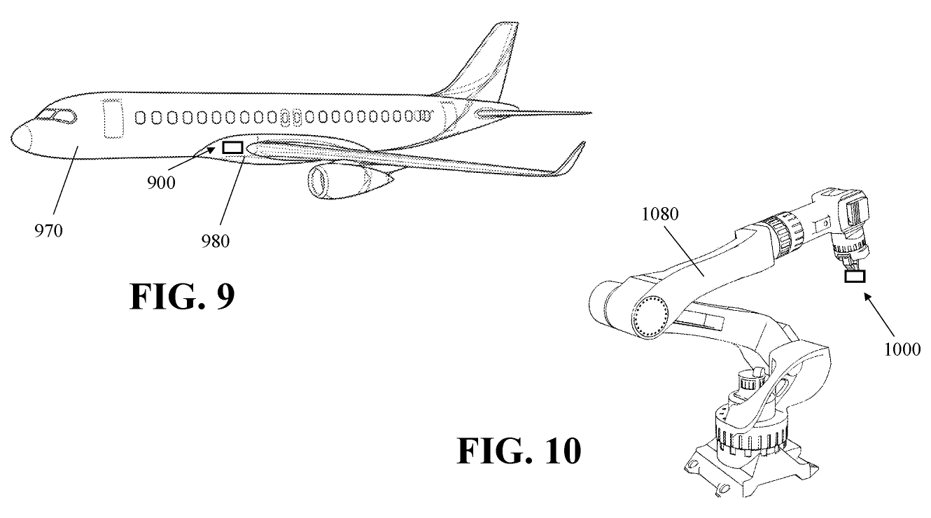

Turning to FIG. 9, a system 900 provided in accordance with the present disclosure and configured according to any of the aspects detailed above is shown integrated into an aircraft 970 including an airframe 980 to be monitored for service life prediction. Although an airframe 980 of an aircraft 970 is illustrated in FIG. 9 for exemplary purposes, the aspects and features of the present disclosure are equally applicable for use with other components and/or other systems.

With reference to FIG. 10, a system 1000 provided in accordance with the present disclosure and configured according to any of the aspects detailed above is shown supported by a mechanical arm 1080. Mechanical arm 1080 may be configured to facilitate coupling system 1000 to any suitable component and/or system for use in determining the service life prediction of the component. For example, in aspects, mechanical arm 1080 is movable to operably position system 1000 to couple to a component for determining the service life prediction of the component. Mechanical arm 1080 is provided for exemplary purposes, as the aspects and features of the present disclosure are equally applicable for use with (or without) other supports and/or auxiliary systems.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular configurations. Those skilled in the art will envision other modifications within the scope and spirit of the claims appended hereto.

What is claimed is:

1. A system for predicting a service life of a metal component subjected to cyclic mechanical loading in a corrosive environment, the system comprising:
a corrosion sensor configured to measure electrochemical currents in a metal component under static loading, the electrochemical currents indicative of a static corrosion current density, i_{corr, static} of the metal component; and
a controller including a processor and a non-transitory computer-readable storage medium storing instructions that, when executed by the processor, cause the processor to:
receive corrosion data from the corrosion sensor, the corrosion data indicative of the measured electrochemical currents;
obtain environmental data relating to a corrosive environment;
obtain loading data relating to mechanical loading of the metal component; and
predict a service life of the metal component based on the corrosion data, the environmental data, and the loading data.

2. The system according to claim 1, further comprising:
at least one environmental sensor configured to sense at least one property of the corrosive environment,
wherein the obtaining the environmental data includes receiving sensed data from the at least one environmental sensor.

3. The system according to claim 1, further comprising:
at least one load sensor configured to sense at least one property of the mechanical loading of the metal component,
wherein the obtaining the loading data includes receiving sensed data from the at least one load sensor.

4. The system according to claim 1, wherein the processor is further caused to:
correlate the static corrosion current density, i_{corr, static} with a fatigue corrosion current density, i_{corr, fatigue}
wherein the predicting the service life of the metal component is based on the fatigue corrosion current density, i_{corr, fatigue}.

5. The system according to claim 1, wherein at least one of the corrosion data, the environmental data, or the loading data corresponds to data from a number of cycles of cyclic mechanical loading of the metal component in the corrosive environment, and wherein the number of cycles is from 1 cycle to 10 cycles.

6. The system according to claim 1, wherein the predicting the service life of the metal component includes predicting a life until fatigue-crack initiation.

7. The system according to claim 1, wherein the predicting the service life of the metal component includes predicting a number of cycles of mechanical loading of the metal component in the corrosive environment.

8. A method for predicting a service life of a metal component subjected to cyclic mechanical loading in a corrosive environment, the method comprising:
sensing electrochemical currents in a metal component under static loading, the electrochemical currents in the metal component under static loading indicative of a static corrosion current density, i_{corr, static} of the metal component;
obtaining environmental data relating to a corrosive environment;
obtaining loading data relating to mechanical loading of the metal component; and
predicting a service life of the metal component based on corrosion data indicative of the measured electrochemical currents, the environmental data, and the loading data.

9. The method according to claim 8, wherein the obtaining the environmental includes sensing at least one property of the corrosive environment.

10. The method according to claim 8, wherein the obtaining the loading data includes sensing at least one property of the mechanical loading of the metal component.

11. The method according to claim 8, further comprising correlating the static corrosion current density, i_{corr, static} with a fatigue corrosion current density, i_{corr, fatigue}.

12. The method according to claim 8, wherein at least one of the corrosion data, the environmental data, or the loading data corresponds to data from a number of cycles of cyclic mechanical loading of the metal component in the corrosive environment, and wherein the number of cycles is from 1 cycle to 10 cycles.

13. The method according to claim 8, wherein the predicting the service life of the metal component includes predicting a life until fatigue-crack initiation.

14. The method according to claim 8, wherein the predicting the service life of the metal component includes predicting a number of cycles of mechanical loading of the metal component in the corrosive environment.

15. A system for predicting a service life of a metal component subjected to cyclic mechanical loading in a corrosive environment, the system comprising:
a sensor head, including:
at least one corrosion sensor configured to measure electrochemical currents in a metal component under static loading, the electrochemical currents in the metal component under static loading indicative of a static corrosion current density, i_{corr, static} of the metal component;
at least one environmental sensor configured to sense at least one property of a corrosive environment; and
at least one load sensor configured to sense at least one property of a mechanical loading of the metal component; and
a controller communicatively coupled to the sensor head, the controller including a processor and a non-transitory computer-readable storage medium storing instructions that, when executed by the processor, cause the processor to:
receive corrosion data from the at least one corrosion sensor of the sensor head, the corrosion data indicative of the measured electrochemical currents;
receive environmental data from the at least one environmental sensor of the sensor head, the environmental data indicative of at least one property of the corrosive environment;
receive loading data from the at least one load sensor of the sensor head, the loading data indicative of the at least one property of the mechanical loading of the metal component; and
predict a service life of the metal component based on the corrosion data, the environmental data, and the loading data.

16. The system according to claim 15, wherein the controller is integrated into the sensor head.

17. The system according to claim 15, wherein the controller is remote from the sensor head during cyclic mechanical loading of the metal component in the corrosive environment.

18. The system according to claim 15, wherein the sensor head is integrated with the metal component or with a system including the metal component.

19. The system according to claim 15, wherein the predicting the service life of the metal component includes predicting a life until fatigue-crack initiation.

20. The method according to claim 15, wherein the predicting the service life of the metal component includes predicting a number of cycles of mechanical loading of the metal component in the corrosive environment.
